(19) United States
(12) Patent Application Publication
(10) Pub. No.: US 2008/0081639 A1
(43) Pub. Date: Apr. 3, 2008

(54) Method for locating a mobile unit using the last registered mobile switching center

(76) Inventors: Richard Robert Boland, LaGrange, IL (US); Mark Alan McCormick, Naperville, IL (US)

Correspondence Address: Lucent Technologies, Inc.;Docket Administrator, Room 3J-219, 101 Crawfords Corner Road, Holmdel, NJ, 07733-3030, US

(21) Appl. No.: 11/541,039

(22) Filed: Sep. 29, 2006

(51) Int. Cl. H04Q 7/20

(52) U.S. Cl. 455/456.1

(57) ABSTRACT

The present invention provides a method for locating a mobile unit. A home Mobile Switching Center (MSC) receives a request for the location of a mobile unit. The home MSC determines a visited MSC that is the last MSC accessed by the mobile unit. The home MSC sends a message requesting the location of the mobile unit to the visited MSC. The visited MSC initiates a location finding process for the mobile unit. If the mobile unit is located at the visited MSC, the visited MSC sends location data relating to the mobile unit to the home MSC.

### FIELD OF THE INVENTION

The present invention relates generally to communication systems, and more particularly to a method for locating a mobile unit.

### BACKGROUND OF THE INVENTION

Mobile units, such as cellular phones, Personal Digital Assistants (PDAs), pagers, and the like, have become nearly ubiquitous. Mobile units have allowed users to travel about while still maintaining the ability to be in near-continuous communication with others.

On occasion, people are not where others expect them to be. For example, a student may be traveling home from college and may not arrive when the student's parents expect the student to arrive. In other scenarios, people do not show up for work and cannot be found in a timely manner by coworkers, friends, or family members.

Since so many people carry a mobile unit with them, locating a missing person's mobile unit can lead to locating the missing person. Therefore, a need exist for a method for locating missing people by identifying the location of their mobile unit.

### BRIEF SUMMARY OF THE INVENTION

The present invention provides a method for determining the location of a mobile unit. The present invention can be utilized in the scenario when a person has become concerned over not being able to reach a user owning a mobile unit. The worried person has made a request to locate the mobile unit. This request may be a call to police or other authorities, or can be a call to the cellular service provider who provides service for the mobile unit.

In accordance with an exemplary embodiment, a request is sent to a wireless network to locate the mobile unit. A home MSC determines the last known location of the mobile unit. This determination will produce the MSC at which mobile unit last registered.

The home MSC sends a request to the last known MSC which the mobile unit registered with. The request is preferably sent via the wireless network that the home MSC and visited MSC are a part of. The request is a query requesting the location of the mobile unit.

After receiving the request from the home MSC, the visited MSC initiates a location finding process for the mobile unit.

The visited MSC determines if the mobile unit is located within the coverage area of the visited MSC. If not, the visited MSC sends a failure message to the home MSC indicating that the mobile unit is not located within the area covered by the visited MSC. The process then ends.

If the mobile unit is located within the area covered by the visited MSC, the visited MSC sends location data relating to the mobile unit to the home MSC. Location data is preferably GPS coordinates, but can alternately be a cell site, a zip code, a street address, a city name, or any other suitable geographic location.

The home MSC records the information pertaining to the mobile unit. The home MSC also outputs information pertaining to the mobile unit to ROP.

The visited MSC determines if it has received a message from the home MSC telling the visited MSC to stop determining the location of the mobile unit. This can occur, for instance, if the person owning the mobile unit has been located. If the visited MSC has received such a message, the process ends. If the visited MSC has not received a stop message, the visited MSC continues the process of locating the mobile unit.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flowchart of a method for determining the location of a mobile unit in accordance with an exemplary embodiment of the present invention.

### DETAILED DESCRIPTION OF THE INVENTION

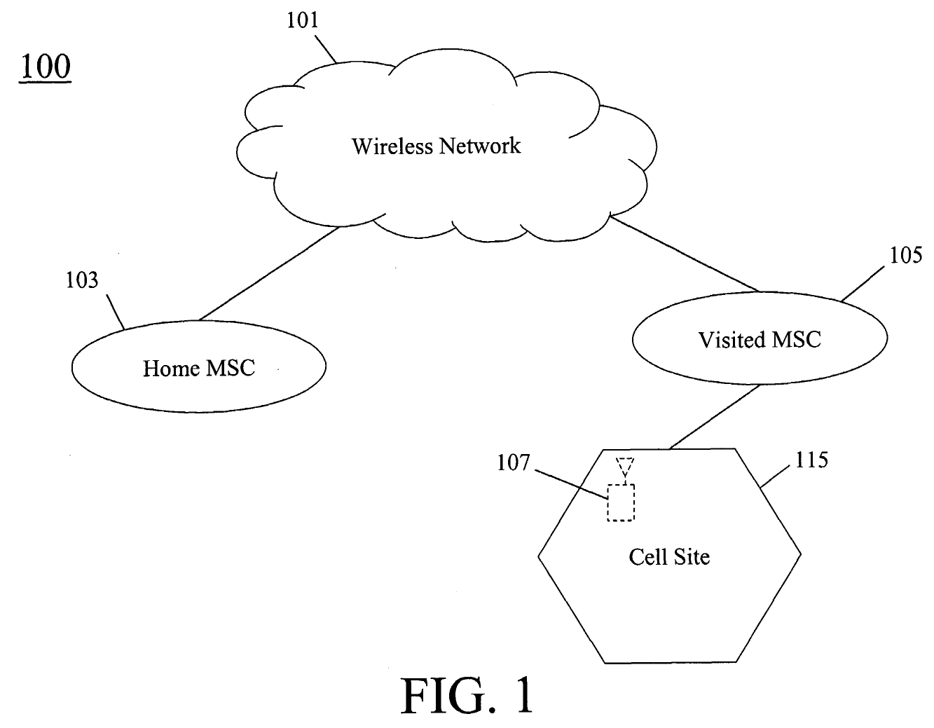

FIG. 1 depicts a communication system 100 in accordance with an exemplary embodiment of the present invention. Communication system 100 includes wireless network 101, Home Mobile Switching Center (MSC) 103, Visited MSC 105, cell site 115, and mobile unit 107.

Wireless network 101 facilitates communication within a cellular network. Wireless network 101 also allows communication with a wireline network via a Public Switched Telephone Network (PSTN). Wireless network 101 can utilize a variety of wireless protocols.

Home MSC 103 typically is coupled to and controls a plurality of base stations, which in turn communicate with mobile units located within their location areas. Each base station is typically responsible for a specific geographical area, commonly referred to as a cell site. Home MSC 103 is preferably responsible for compiling call information for billing and handing off calls from one cell to another. In an exemplary embodiment, Home MSC 103 is a CDMA MSC.

Visited MSC 105 typically is coupled to and controls a plurality of base stations, which in turn communicate with mobile units located within their location areas. Only one cell site, cell site 115, is depicted in FIG. 1 for clarity purposes.

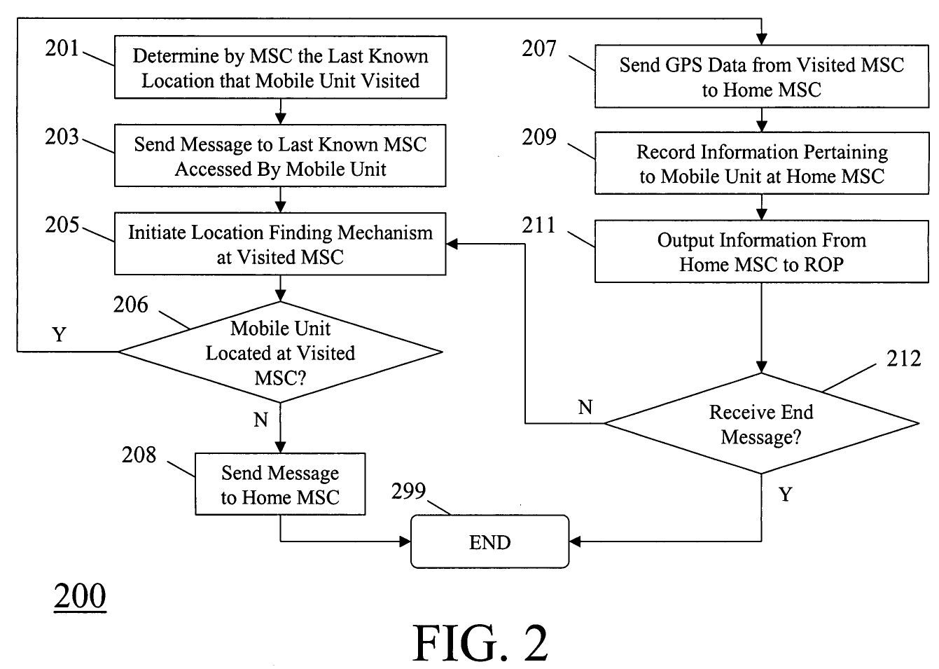

Mobile unit 107 is a portable unit that is registered with Home MSC 103. Although mobile unit 107 is registered at Home MSC 103, mobile unit 107 can travel throughout communication system 100 and place and receive calls at other MSCs. As depicted in FIGS. 1 and 2, mobile unit 107 was last registered within coverage area 115 of Visited MSC 105.

FIG. 2 depicts a flowchart 200 of a method for determining the location of a mobile unit in accordance with an exemplary embodiment of the present invention. In accordance with an exemplary embodiment, a person has become concerned over not being able to reach a user owning mobile unit 107. The worried person has made a request to locate mobile unit 107. This request may be a call to police or other authorities, or can be a call to the cellular service provider who provides service for mobile unit 107.

A request is sent to wireless network 101 to locate mobile unit 107. Home MSC 103 determines (201) the last known location of mobile unit 107. This determination will produce the MSC at which mobile unit 107 last registered. In the exemplary embodiment depicted in FIGS. 1 and 2, mobile unit 107 last registered with visited MSC 105. Registration occurs when mobile unit 107 registers with visited MSC 105. In an exemplary embodiment, ANSI-41 and GSM/UMTS send a message to home MSC 103 to inform home MSC 103 that mobile unit 107 is now within the area covered by visited MSC 105. Home MSC 103 stores this information for later use and sends a profile of mobile unit 107 to visited MSC 105. In addition, home MSC 103 sends the previous last known location of mobile unit 207 to remove its copy of the subscriber's data.

Home MSC 103 sends (203) a request to the last known MSC which mobile unit 107 registered with. In the exemplary embodiment depicted in FIG. 2, mobile unit 107 last registered with visited MSC 105. The request is preferably sent via wireless network 101 and requests the location of mobile unit 107.

After receiving the request from Home MSC 103, Visited MSC 105 initiates (205) a location finding process for mobile unit 107. The visited MSC sends an SDPP message to mobile unit 107 to inform mobile unit 107 that it is to send its GPS information to home MSC 103. Mobile unit 107 determines its position with the information sent and the use of a pilot system, which preferably comprises three pilot signals. The information is sent to Home MSC 103.

Visited MSC 105 determines (206) if mobile unit 107 is located within the coverage area of visited MSC 105. If not, visited MSC 105 sends (208) a failure message to home MSC 103 indicating that mobile unit 107 is not located within the area covered by visited MSC 105. The process then ends (299).

If mobile unit 107 is located within the area covered by visited MSC 105 as determined at step 206, processing continues at step 207. Visited MSC 105 sends (207) location data relating to mobile unit 107 to Home MSC 103. Location data is preferably GPS coordinates, but can alternately be a cell site, a zip code, a street address, a city name, or any other suitable geographic location.

Home MSC 103 records (209) the information pertaining to mobile unit 107. In an exemplary embodiment, Home MSC 103 stores the information in a database, and includes the subscriber's record. In an alternate exemplary embodiment, home MSC 103 stores the information in a file in a working directory on home MSC 103. Further, home MSC 103 can send the information to the “ROP”, or it may send the information to a processor in wireless network 101 for further evaluation.

Home MSC 103 outputs (211) information pertaining to mobile unit 107 to an ROP. In an exemplary embodiment, home MSC 103 outputs the GPS coordinates onto the ROP using a write primitive.

Visited MSC 105 determines (212) if it has received a message from Home MSC 103 telling visited MSC 105 to stop determining the location of mobile unit 107. If visited MSC 105 has received such a message, the process ends (299). If visited MSC 105 has not received a stop message at step 212, processing returns to step 205, where visited MSC 105 continues the location finding mechanism.

While this invention has been described in terms of certain examples thereof, it is not intended that it be limited to the above description, but rather only to the extent set forth in the claims that follow.

We claim:

1. A method for locating a mobile unit, the method comprising:
receiving a request for the location of a mobile unit at a home Mobile Switching Center (MSC) of the mobile unit;
determining a visited MSC, the visited MSC being the last MSC accessed by the mobile unit;
sending a message to the visited MSC, the message requesting the location of the mobile unit;
initiating a location finding process for the mobile unit at the visited MSC; and
if the mobile unit is located at the visited MSC, sending location data relating to the mobile unit to the home MSC.

2. A method for locating a mobile unit in accordance with claim 1, further comprising the step of, if the mobile unit is not located at the visited MSC, sending a failure message to the home MSC.

3. A method for locating a mobile unit in accordance with claim 1, wherein the location data comprises GPS coordinates.

4. A method for locating a mobile unit in accordance with claim 1, wherein the location data comprises a cell site.

5. A method for locating a mobile unit in accordance with claim 1, wherein the location data comprises a zip code.

6. A method for locating a mobile unit in accordance with claim 1, wherein the location data comprises a street address.

7. A method for locating a mobile unit in accordance with claim 1, wherein the location data comprises a city name.

8. A method for locating a mobile unit in accordance with claim 1, the method further comprising the step of recording the location data at the home MSC.

9. A method for locating a mobile unit in accordance with claim 8, further comprising the step of outputting the location date to an ROP.

10. A method for locating a mobile unit in accordance with claim 1, the method further comprising the step of determining at the visited MSC if the visited MSC has received a stop message from the home MSC, the stop message indicating that the visited MSC should stop determining the location of the mobile unit.

11. A method for locating a mobile unit in accordance with claim 10, the method further comprising the step of continuing the location finding mechanism if the visited MSC has not received the stop message.
